(19) United States
(12) Patent Application Publication
(10) Pub. No.: US 2026/0042228 A1
(43) Pub. Date: Feb. 12, 2026

(54) ROBOTIC HANDS AND ROBOTIC SYSTEMS COMPRISING THE SAME

(71) Applicant: Hong Kong Centre for Logistics Robotics Limited, Hong Kong (CN)

(72) Inventors: Jianshu ZHOU, Hong Kong (CN); Junda HUANG, Hong Kong (CN); Yunhui LIU, Hong Kong (CN)

(21) Appl. No.: 18/798,754

(22) Filed: Aug. 8, 2024

(51) Int. Cl. B25J 15/00; B25J 15/02; B25J 17/02

(52) U.S. Cl. CPC B25J 15/0009; B25J 15/0023; B25J 15/0206; B25J 17/0275

(57) ABSTRACT

In one aspect, provided is a robotic hand, comprising a plurality of robotic fingers; and a robotic palm, configured to operatively connect with the plurality of robotic fingers, wherein individual robotic finger comprises: a first phalanx; a second phalanx; and a first hydraulic actuator, configured to operatively connect the first phalanx with the second phalanx, wherein the first hydraulic actuator comprises a soft, bellows-type deformable body, such that when in operation, the first hydraulic actuator is switchable between at least a compression status and an extension status, in response to external force and/or hydraulic pressure applied thereto. Other example embodiments are described herein. In certain embodiments, the disclosure provides robotic hands and systems that showed high degrees of compliance, adaptability, and precise control for robotic applications and addressed the challenge of achieving robotic fine in-hand manipulation.

### FIELD OF INVENTION

This application relates to robotics in particular, robotic hands and robotic systems comprising the same.

### BACKGROUND OF INVENTION

The advancement of robotics has necessitated the development of sophisticated actuation mechanisms capable of fine, delicate, and dexterous manipulation. Traditional rigid actuation mechanisms often fall short in achieving the compliance and adaptability required for intricate tasks. There is an urgent need for alternative or improved robotic hands and systems.

### SUMMARY OF INVENTION

In light of the foregoing background, in certain embodiments, it is an object to provide novel robotic hands and systems with soft hydraulic actuation mechanism designed to enhance the dexterity and compliance of robotic systems, such as in applications requiring fine in-hand manipulation.

In some embodiments, provided is a robotic hand, including: a plurality of robotic fingers; and a robotic palm, configured to operatively connect with the plurality of robotic fingers, wherein individual robotic finger includes: a first phalanx; a second phalanx; and a first hydraulic actuator, configured to operatively connect the first phalanx with the second phalanx, wherein the first hydraulic actuator includes a soft, bellows-type deformable body, such that when in operation, the first hydraulic actuator is switchable between at least a compression status and an extension status, in response to external force and/or hydraulic pressure applied thereto.

In some embodiments, provided is a robotic system, including: a robotic hand as mentioned in preceding embodiment(s); and optionally a robotic arm operatively connected with the robotic hand.

There are many advantages of the invention. In some embodiments, the provided robotic hands and systems addressed the challenge of achieving robotic fine in-hand manipulation comparable to human dexterity by improving on existing low-complexity hands. In certain embodiments, this invention pertains to a soft hydraulic actuation mechanism in the robotic hand that provides high degrees of compliance, adaptability, and precise control for robotic applications. In certain embodiments, the mechanism utilizes origami-inspired soft hydraulic actuators driven by syringe pumps to achieve complex movements. In certain embodiments, these actuators offer significant expansion ratios and durability, enabling fine manipulation tasks with minimal risk of damage. In certain embodiments, the soft hydraulic actuation mechanism is versatile and can be integrated into various robotic systems, including the provided Dexterous and Compliant robotic hands (namely DexCo hand), which serve as an example practical application of this technology. In certain embodiments, the provided robotic hands and systems addressed the need for a robust, adaptable, and precise actuation mechanism that can mimic human-like dexterity in robotic applications.

In certain embodiments, soft hydraulic actuators are used in the provided robotic hands and systems, which allow the fingers to adapt to various shapes and exert controlled forces without damaging the objects or the hand itself.

In certain embodiments, the DexCo hand employs a soft hydraulic actuation mechanism where syringe pumps control the hydraulic fluid volume in the actuators, providing high force output and precise control over finger movements. This mechanism ensures bidirectional driving capabilities, allowing the fingers to both push and pull with precise force.

In certain embodiments, the soft hydraulic actuators provide local compliance, allowing the fingers to conform to the contours of objects and apply appropriate force. This adaptability enhances the hand's ability to perform delicate tasks and reduces the likelihood of damage.

In certain embodiments, the DexCo hand incorporates linear potentiometers and Inertial Measurement Units (IMUs) to provide real-time feedback on the positions and angles of the fingers. This advanced sensing capability ensures accurate control and coordination of finger movements, enabling complex manipulation tasks.

In certain embodiments, the DexCo hand's modular finger design allows for configurations with two, three, or four fingers, each with three degrees of freedom. This modularity provides flexibility in adapting the hand to different tasks and environments.

In certain embodiments, in the DexCo hand, the soft hydraulic actuators operate based on hydrostatic pressure. The syringe pumps modulate the volume of hydraulic fluid, causing the actuators to expand or contract proportionally, providing controlled and powerful actuation.

In certain embodiments, in the DexCo hand, the universal joints at the base of each finger enable independent flexion/extension and adduction/abduction movements, closely mimicking the dexterous base joints of a human finger.

In certain embodiments, the soft hydraulic actuators in the DexCo hand enable bidirectional driving, allowing for more versatile manipulation capabilities.

In some embodiments, the integration of a universal joint alongside a soft hydraulic actuation mechanism is a pivotal aspect of the provided robotic hands and systems. In some embodiments, the universal joint, is actuated by a pair of hydraulic actuators through differential actuation. This innovative approach not only empowers the mechanical robotic hand to achieve universal joint motion with minimal actuation but also facilitates easy embedding of proprioception. In some embodiments, operating under hydrostatic pressure, the soft-rigid hybrid actuation system contributes local compliance and bidirectional driving capabilities. In some embodiments, this local compliance takes full advantage of the benefits associated with soft materials, establishing a resilient interaction space and reducing the risk of hardware damage. Collectively, in some embodiments, these features enable the mechanical robotic hand to replicate the functions of human thumbs and index fingers while concurrently optimizing the hardware structure to the greatest extent possible.

### BRIEF DESCRIPTION OF FIGURES

FIG. 1A is a schematic diagram of an example robotic hand with two robotic fingers according to an example embodiment.

FIG. 1B is a schematic diagram of a perspective view of the example robotic hand, according to an example embodiment of FIG. 1A.

FIG. 1C is a schematic diagram of the robotic finger, according to an example embodiment of FIG. 1A.

FIG. 1D is a schematic diagram of a front view of the robotic finger, according to an example embodiment of FIG. 1A.

FIG. 2A is a schematic diagram of an exploded side view of a robotic finger according to an example embodiment.

FIG. 2B is a schematic diagram of an exploded perspective view of the robotic finger, according to an example embodiment of FIG. 2A.

FIG. 2C is a schematic diagram of a universal joint connecting the second and the third phalanxes of a robotic finger according to an example embodiment of FIG. 2A.

FIG. 3A is a schematic front view of a hydraulic actuator according to an example embodiment.

FIG. 3B is a schematic perspective view of a hydraulic actuator according to an example embodiment of FIG. 3A.

FIG. 3C is a schematic top view of a hydraulic actuator according to an example embodiment of FIG. 3A.

FIG. 3D is a schematic front view of the hydraulic actuator in a bent state, according to an example embodiment of FIG. 3A.

FIG. 3E is a schematic perspective view of the hydraulic actuator in a bent state, according to an example embodiment of FIG. 3A.

FIG. 3F is a schematic top view of the hydraulic actuator in a bent state, according to an example embodiment of FIG. 3A.

FIG. 3G is a schematic diagram of a hydraulic actuator transition from the compression status to the extension status, according to an example embodiment.

FIG. 3H a schematic diagram of a hydraulic actuator transition from the compression status to the extension status according to an example embodiment.

FIG. 3I is a schematic diagram of a hydraulic actuator in the bent state and compression status, transits to the extension status, according to an example embodiment.

FIG. 3J is a schematic diagram of a hydraulic actuator in the compression status, transits to the bent state and extension status, according to an example embodiment.

FIG. 3K is a schematic side view showing locking structures of the actuator to install between two elements, according to an example embodiment.

FIG. 3L is a cross-sectional view showing locking structures of the actuator to install between two elements, according to an example embodiment of FIG. 3K. FIG. 3M is a schematic diagram of a hydraulic actuator being passively stretched due to external force, according to an example embodiment.

FIG. 3N is a schematic diagram of a hydraulic actuator being passively compressed due to external force, according to an example embodiment.

FIG. 3O is a schematic diagram of a hydraulic actuator in a bent state being passively stretched due to external force, according to an example embodiment.

FIG. 3P is a schematic diagram of a hydraulic actuator in a bent state being passively compressed due to external force, according to an example embodiment.

FIG. 4A is a schematic diagram of the first and the second phalanxes of a robotic finger with the first hydraulic actuator in an extended state, according to an example embodiment.

FIG. 4B is a schematic diagram of the first and the second phalanxes of a robotic finger with the hydraulic actuator in an compressed state, according to an example embodiment.

FIG. 5A is a schematic diagram showing the bending of the second phalanx resulting from the elongation of the pair of hydraulic actuators, according to an example embodiment.

FIG. 5B is a schematic diagram showing the extension of the second phalanx resulting from the compression of the pair of hydraulic actuators, according to an example embodiment.

FIG. 5C is a schematic diagram showing the inclination of the second phalanx towards the left side driven by the hydraulic actuators, according to an example embodiment.

FIG. 5D is a schematic diagram showing the inclination of the second phalanx towards the right side driven by the hydraulic actuators, according to an example embodiment.

FIG. 6A is a schematic diagram of a robotic palm according to an example embodiment.

FIG. 6B is a schematic diagram of a top view of the robotic palm according to an example embodiment of FIG. 6B.

FIG. 7 is a schematic diagram of an example robotic hand with three robotic fingers according to an example embodiment.

FIG. 8 is a schematic diagram of an example robotic hand with four robotic fingers according to an example embodiment.

FIG. 9 is a schematic diagram of another example robotic hand with four robotic fingers according to an example embodiment.

FIG. 10A is a schematic diagram of a teleoperated robotic system according to an example embodiment.

FIG. 10B is a schematic diagram of a teleoperated robotic system showing components of some of the elements according to an example embodiment.

FIGS. 11A-11G are schematic diagrams of various manipulation demonstrations of an example robotic system according to an example embodiment. (A) Screw On and Screw Off a real light bulb. (B) Card box opening. (C) Picking and sorting pills based on size with in-finger manipulation. (D) Cluttered bin picking with finger-environmental interaction. (E) Counting Cards and taking card out one by one. (F) Plastic bag opening. (G) Typical caging manipulation and in-hand rotation.

### DETAILED DESCRIPTION

As used herein and in the claims, the terms “comprising” (or any related form such as “comprise” and “comprises”), “including” (or any related forms such as “include” or “includes”), “containing” (or any related forms such as “contain” or “contains”), means including the following elements but not excluding others. It shall be understood that for every embodiment in which the term “comprising” (or any related form such as “comprise” and “comprises”), “including” (or any related forms such as “include” or “includes”), or “containing” (or any related forms such as “contain” or “contains”) is used, this disclosure/application also includes alternate embodiments where the term “comprising”, “including,” or “containing,” is replaced with “consisting essentially of” or “consisting of”. These alternate embodiments that use “consisting of” or “consisting essentially of” are understood to be narrower embodiments of the “comprising”, “including,” or “containing,” embodiments.

For the sake of clarity, “comprising”, including, and “containing”, and any related forms are open-ended terms which allows for additional elements or features beyond the named essential elements, whereas “consisting of” is a closed end term that is limited to the elements recited in the claim and excludes any element, step, or ingredient not specified in the claim.

For the sake of clarity, “characterized by” or “characterized in” (together with their related forms as described above), does not limit or change the nature of whether the list of terms following it are open or closed. For example, in a claim directed towards “a composition comprising A, B, C, and characterized in D, E, and F”, the elements D, E, and F are still open-ended terms and the claim is meant to include other elements due to the use of the word “comprising”earlier in the claim.

“Consisting essentially of” limits the scope of a claim to the specified materials, components, or steps (“essential elements”) that do not materially affect the essential characteristic(s) of the claimed invention. In some embodiments, the essential characteristics are the basic and novel characteristic(s) of the claimed invention.

As used herein, the singular forms “a”, “an” and “the” are intended to include the plural forms as well, unless the context clearly indicates otherwise. Where a range is referred in the specification, the range is understood to include each discrete point within the range. For example, 1-7 means 1, 2, 3, 4, 5, 6, and 7.

As used herein, the term “about” is understood as within a range of normal tolerance in the art and not more than ±10% of a stated value. By way of example only, about 50 means from 45 to 55 including all values in between. As used herein, the phrase “about”a specific value also includes the specific value, for example, about 50 includes 50.

As used herein, the term “soft robotics” refers to the use of flexible and compliant materials to create or form at least a portion or a component of robots. In some examples, soft robotics can safely interact with their environment.

As used herein and in the claims, the terms “general” or “generally”, or “substantial” or “substantially” mean that the recited characteristic, angle, shape, state, structure, or value need not be achieved exactly, but that deviations or variations, including for example, tolerances, measurement error, measurement accuracy limitations and other factors known to those of skill in the art, may occur in amounts that do not preclude the effect the characteristic was intended to provide. For example, an object that has a “generally” cylindrical shape would mean that the object has either an exact cylindrical shape or a nearly exact cylindrical shape. In another example, an object that is “substantially” perpendicular to a surface would mean that the object is either exactly perpendicular to the surface or nearly exactly perpendicular to the surface, e.g., has a 5% deviation.

It is to be understood that terms such as “proximal”, “distal”, “top”, “bottom”, “iddle”, “side”, “length”, “width”, “longitudinal”, “transverse”, “vertical”, “inner”, “outer”, “interior”, “exterior,” and the like as may be used herein, merely describe points of reference and do not limit the present invention to any particular orientation or configuration.

As used herein, the term “hydraulic actuation” refers to the use of hydraulic power to drive a robotic hand or system.

As used herein, the term “proprioception” refers to the system's ability to detect or sense its own position, orientation, and/or movement.

As used herein, the term “modular” refers to feature of constructing robots with interchangeable and reconfigurable modules.

As used herein, the term “compliance” refers to the ability of a robotic system to adapt to its environment by deforming in response to external forces.

As used herein, the term “hydrostatic pressure” is the pressure exerted by a fluid at equilibrium due to the force of gravity. In some examples, the force of gravity refers to elasticity force of bellows of an actuator.

As used herein, the term “universal joint” refers to a component, a structure or a mechanism that allows for multi-axis rotation, providing at least two degrees of freedom in a single joint.

As used herein, the term “bidirectional driving” refers to the ability of an actuator to move in two directions (e.g., push and pull) with controlled force.

As used herein, the term “robotic hand” refers to a device at the end of a robotic arm to interact with the environment, such as to grasp and/or manipulates one or more objects. In some examples, example robotic hand may be named as “DexCo Hand”.

As used herein, the term “robotic finger” or “finger” refers to a part or a component of a robotic hand that is actuated by actuator to perform the grasping and/or manipulating of one or more objects. In certain embodiments, the robotic finger is a structure / mechanism which contains two or more phalanxes jointed by a joint and is capable of flexion/extension and/or adduction/abduction movements.

As used herein, the term “robotic palm” or “palm” refers to a part or a component of a robotic hand that is operatively connects with one or more robotic fingers. In some examples, the robotic palm is also configured to operatively connect with a robotic arm. In certain embodiments, the robotic palm acts as a base to which the robotic fingers and other components to attach.

As used herein, the term “flexion” refers to an action of bending a joint, which decreases the angle between the phalanges jointed by the joint.

As used herein, the term “extension” refers to an action of straightening or opening a joint, which increases the angle between the phalanges jointed by the joint.

As used herein, the term “adduction” refers to a motion towards a center or midline of a body.

As used herein, the term “abduction” refers to a motion away from a center or midline of a body.

As used herein, the term “phalanx”, “phalanxes”, “phalange” or “phalanges” refers to one or more components, parts or forming units that make up the robotic finger structure.

As used herein, the term “joint” or “link” refers to a component or connection between two phalanges that make up at least part of a finger. In certain embodiments, the joint provides the functionality of flexion/extension/adduction/abduction movements for a robotic finger.

As used herein, the term “phalanx base” refers to a part or a component of a phalanx which acts as a basal structure to connect the phalanx with the robotic palm. In certain embodiments, the phalanx base is sized and shaped to be slidably connected with the robotic palm.

As used herein, the term “rotation” refers to having the ability to rotate, for example, having the ability to perform an act, function, or operation in turn.

As used herein, “connecting”, “connected” and “connection” means directly or indirectly physically bound to other elements.

As used herein and in the claims, the term “operatively connects with” or “operatively connects to” refers to a functional or operational connection between two components or systems that allows them to work together or interact with each other. Such connection may be direct or indirect.

As used herein, the term “working face” refers to a face or surface of a phalanx that may directly interact or contact with a target object(s) for grasping and/or manipulating the same.

As used herein, the term “hydraulic actuator” or “actuator” refers to a mechanism or component that actuates (e.g., elongates, compresses, expands, contracts or bends) a part (e.g., phalange) in response to modulation of a hydraulic fluid and/or external force. In some examples, the hydraulic actuator(s) features bellows-type structure and is mounted between two phalanxes for manipulation and control of the robotic hand.

As used herein, the terms “original state” and “normal state” refer to a state of the hydraulic actuator is the default or resting state of the actuator that is not being actively controlled or powered.

As used herein, the terms “compressed state” or “compression status” refers to a state of the hydraulic actuator that the overall length, size or volume is relatively smaller when compared to that in original or normal state. For clarity sake, the hydraulic actuator may have various degrees of compressed states.

As used herein, the terms “extended state” or “extension status” refers to a state of the hydraulic actuator that the overall length, size or volume is relatively larger when compared to that in original or normal state. For clarity sake, the hydraulic actuator may have various degrees of extended states.

As used herein, the term “bent state” refers to a state of the hydraulic actuator that the length of one side of the hydraulic actuator is relatively larger that of the opposing side. For clarity sake, the hydraulic actuator may have various degrees of bent states.

Although the description referred to embodiments, the disclosure should not be construed as limited to the embodiments set forth herein.

### Numbered Embodiments

Embodiment 1. A robotic hand, comprising: a plurality of robotic fingers; and a robotic palm, configured to operatively connect with the plurality of robotic fingers, wherein individual robotic finger comprises: a first phalanx; a second phalanx; and a first hydraulic actuator, configured to operatively connect the first phalanx with the second phalanx, wherein the first hydraulic actuator comprises a soft, bellows-type deformable body, such that when in operation, the first hydraulic actuator is switchable between at least a compression status and an extension status, in response to external force and/or hydraulic pressure applied thereto.

Embodiment 2. The robotic hand of embodiment 1, wherein the first hydraulic actuator is operatively connected with and driven by a hydraulic system comprising a syringe pump.

Embodiment 3. The robotic hand of embodiment 2, wherein the syringe pump is configured to be controlled by a stepper motor.

Embodiment 4. The robotic hand of any of the preceding embodiments, wherein the bellows-type deformable body is configured to connect with the syringe pump via flexible hydraulic line.

Embodiment 5. The robotic hand of any of the preceding embodiments, wherein the individual first phalanx and/or the individual second phalanx comprise a working face comprising a silicone pad thereon.

Embodiment 6. The robotic hand of any of the preceding embodiments, wherein the robotic finger further comprises a third phalanx and at least one second hydraulic actuator, wherein the at least one second hydraulic actuator is configured to operatively connect the second phalanx with the third phalanx.

Embodiment 7. The robotic hand of any of the preceding embodiments, wherein the robotic finger further comprises a revolute shaft connecting the first phalanx with the second phalanx.

Embodiment 8. The robotic hand of any of embodiments 5 to 7, wherein the robotic finger further comprises a universal joint connecting the second phalanx with third phalanx.

Embodiment 9. The robotic hand of embodiment 8, wherein the third phalanx further comprises a baffle for securing the universal joint.

Embodiment 10. The robotic hand of any of embodiments 5 to 9, wherein the third phalanx further comprises a phalanx base for connecting third phalanx with the robotic palm.

Embodiment 11. The robotic hand of any of the preceding embodiments, wherein the robotic finger further comprises a proprioceptive sensor operatively connect with individual actuator.

Embodiment 12. The robotic hand of embodiment 11, wherein the proprioceptive sensor comprises IMU and/or potentiometer.

Embodiment 13. The robotic hand of any of the preceding embodiments, wherein the robotic palm comprises a pneumatic slide rail, and the robotic hand is configured to slidably connect with the pneumatic slide rail.

Embodiment 14. The robotic hand of any of the preceding embodiments, wherein each of the first hydraulic actuator and the at least one second hydraulic actuator comprise a head portion at each opposing end, individual first phalanx, second phalanx and third phalanx, if present, comprises a receiving portion configured to receive the head portion.

Embodiment 15. A robotic hand, comprising: a plurality of robotic fingers; and a robotic palm, configured to operatively connect with the plurality of robotic fingers, wherein individual robotic finger comprises: a first phalanx; a second phalanx; a third phalanx; a first hydraulic actuator, configured to operatively connect the first phalanx with the second phalanx; a pair of second hydraulic actuators, wherein the pair of second hydraulic actuators are configured to operatively connect the second phalanx with the third phalanx; a revolute joint connecting the first phalanx with the second phalanx; and a universal joint connecting the second phalanx with the third phalanx; and wherein each of the first hydraulic actuator and the pair of second hydraulic actuators comprise a soft, bellows-type deformable body, such that when in operation, the first hydraulic actuator and the pair of second hydraulic actuator are switchable between at least a compression status and an extension status, respectively, in response to external force and/or hydraulic pressure applied thereto.

Embodiment 16. A robotic system, comprising: a robotic hand as claimed in any one of the preceding embodiments; and optionally a robotic arm operatively connected with the robotic hand.

Embodiment 17. The robotic system, further comprising: a hydraulic driving unit, configured to provide hydraulic pressure to the robotic hand; and an operating unit, configured to provide operating signal to the hydraulic driving unit.

Embodiment 18. The robotic system of embodiment 17, wherein the hydraulic driving unit further comprises a controlling unit, configured to provide control signals to the hydraulic driving unit.

Embodiment 19. The robotic system of embodiment 17, wherein the hydraulic driving unit comprises a syringe pump system.

Embodiment 20. The robotic system of embodiment 19, wherein the syringe pump system comprises a stepper motor and a hydraulic syringe, and the controlling unit comprises a stepper motor driver.

### EXAMPLES

Provided herein are examples that describe in more detail certain embodiments of the present disclosure. The examples provided herein are merely for illustrative purposes and are not meant to limit the scope of the invention in any way. All references given below and elsewhere in the present application are hereby included by reference.

In certain embodiments, structural design of provided robotic hand, DexCo Hand, incorporates flexion and adduction/abduction movements, finger opposition, and palm dexterity, mirroring the motions of human fingers.

### Robotic Hand

### Example 1

### Example Robotic Hand

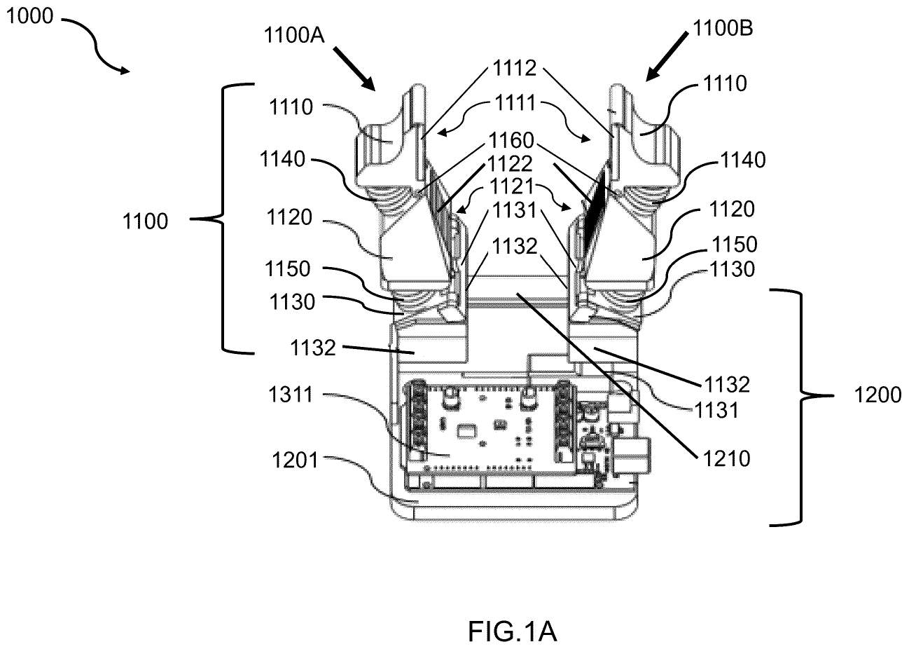

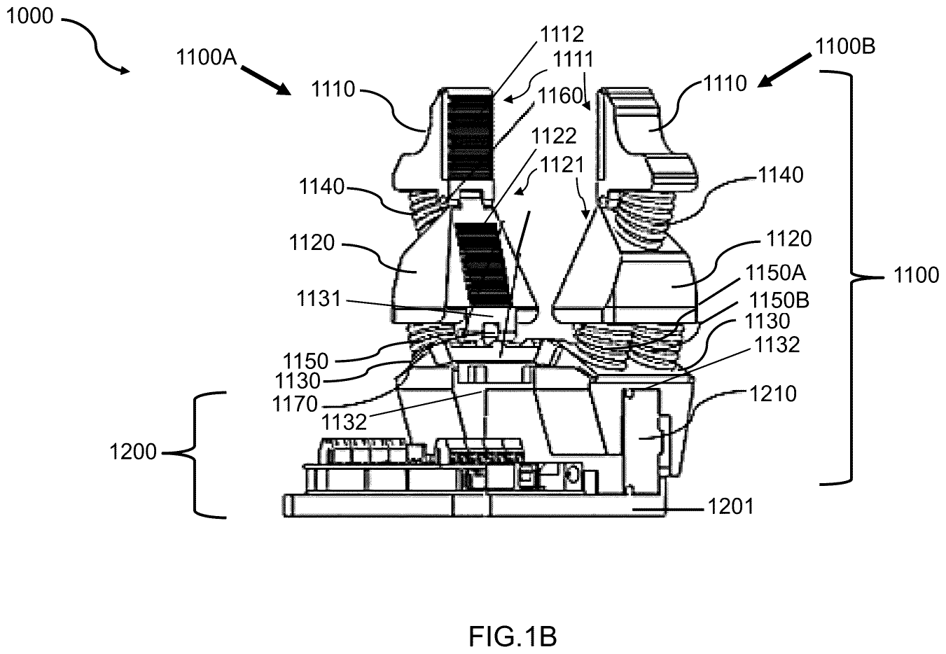

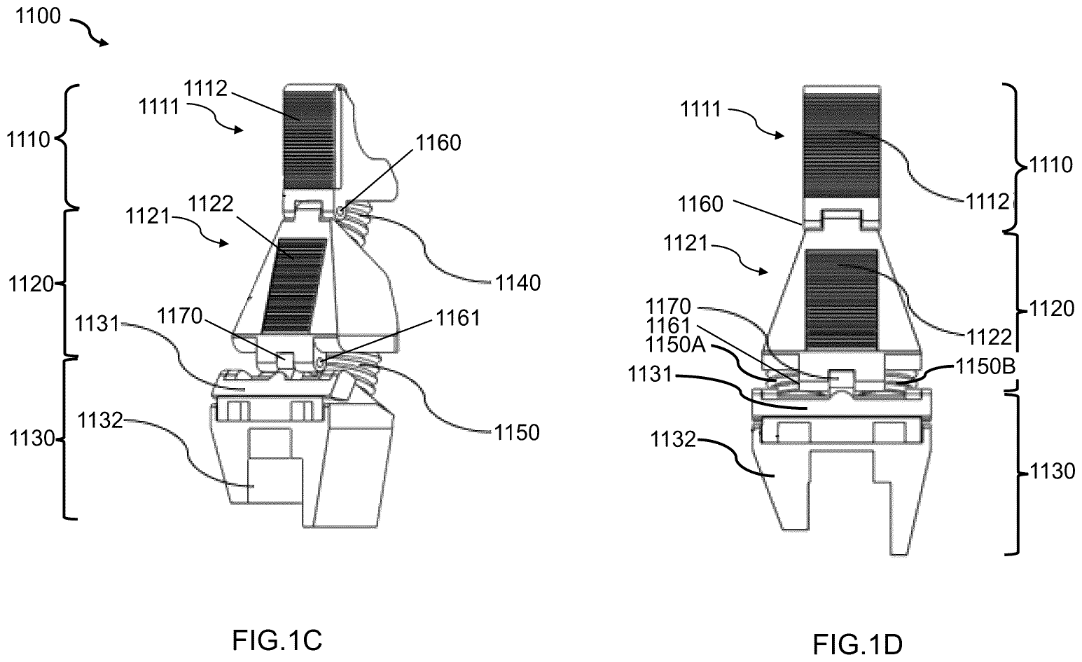

Now referring to FIGS. 1A and 1B, example robotic hand 1000 generally contains at least two robotic fingers 1100A and 1100B (which is generally referred as 1100) and a robotic palm 1200. In this example, two robotic fingers 1100A and 1100B are provided and they are operatively connected with or mounted on the robotic palm 1200. Detailed structures of robotic fingers 1100 and robotic palm 1200 will be described in more detail later.

### Robotic Fingers

Now referring to FIGS. 1A-1B, and FIGS. 1C-1D, robotic fingers are featured as modular units. In this example, each robotic finger 1100 generally contains a finger tip or first phalanx 1110, a proximal link or second phalanx 1120 and a base link or third phalanx 1130. The first phalanx 1110 and the second phalanx 1120 are constructed and arranged to be connected by a first shaft 1160, serving as a pivot point for a first (revolute) joint at the finger tip. Similarly, the second phalanx 1120 and the third phalanx 1130 are constructed and arranged to be connected by a universal joint 1170, providing two degrees of freedom for a second joint at the proximal link. The first phalanx 1110 is configured to be capable of flexion and extension, and the second phalanx 1120 is configured to be capable of flexion, extension, adduction and abduction.

Hydraulic actuators 1140, 1150A and 1150B (collectively 1150), which are driven by hydraulic power, are provided between the first and second phalanxes 1110 and 1120, and between the second and third phalanxes 1120 and 1130, respectively, so as to control hydraulic actuation of the robotic finger 1100. A first hydraulic actuator 1140 is provided between the first and second phalanxes 1110 and 1120, to drive the flexion and extension of the first phalanx 1110. A pair of (two) second hydraulic actuators 1150A and 1150B are provided between the second phalanx 1120 and the third phalanx 1130, to drive the flexion, extension, adduction and abduction of the second phalanx 1120.

In this example, silicone pads 1112 and 1122 with parallel saw-tooth surface are provided at the working faces 1111 and 1121 of the first phalanx 1110 and the second phalanx 1120, respectively, increasing the friction between the finger 1100 and a target object.

The third phalanx 1130 generally contains a baffle 1131 and a phalanx base 1132. To operatively connect the robotic finger 1100 with the robotic palm 1200, the phalanx base 1132 is sized and shaped such as to slidably receive in or fixed to a pneumatic slide rail 1210 or palm slider of the robotic palm 1200, which will be described in more details later.

### Example 2

### Exploded Views of an Example Robotic Finger

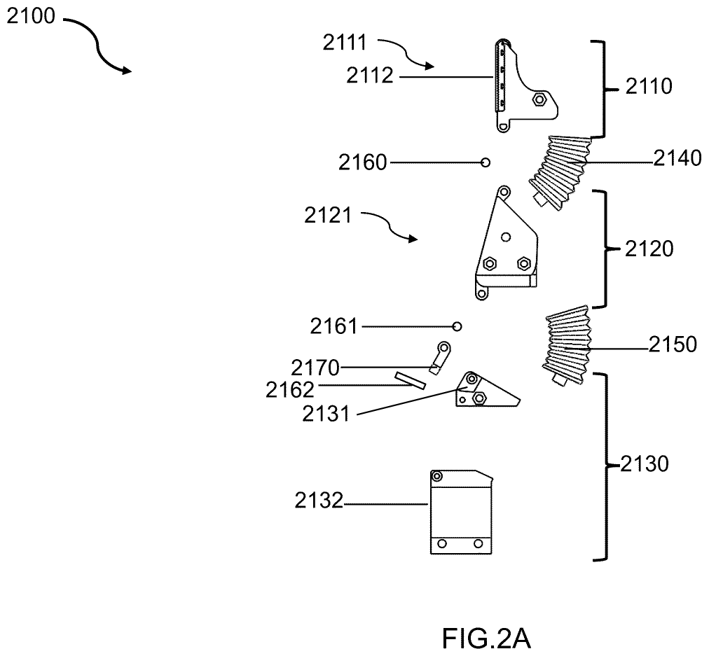

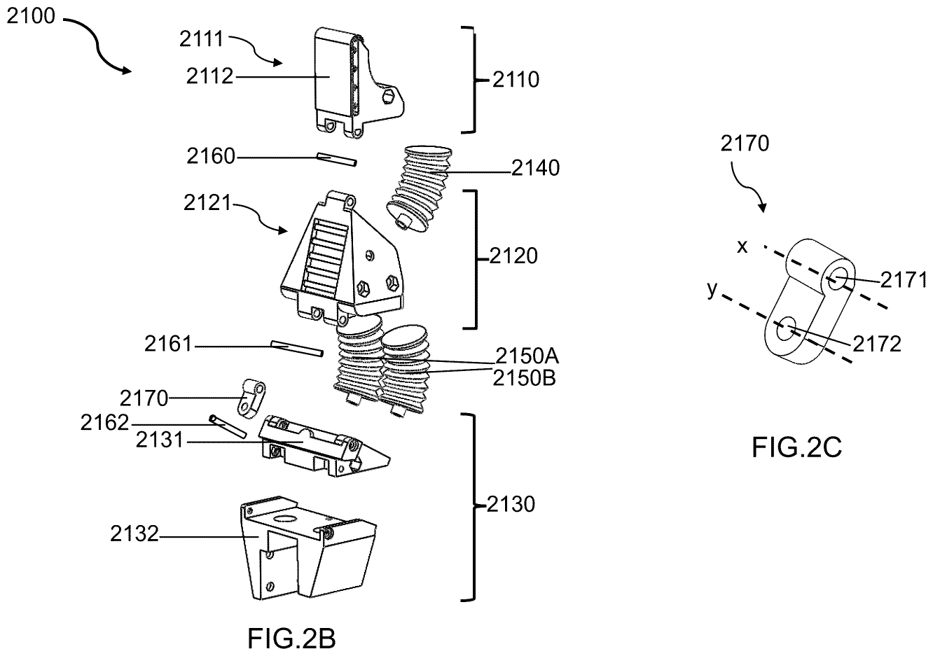

FIGS. 2A-2B showed another example robotic finger 2100 in exploded views. Similar to Example 1, the robotic finger 2100 generally contains a first phalanx 2110, a second phalanx 2120 and a third phalanx 2130. These phalanxes encompass three degrees of freedom, formed by two joints 2160 and 2170. In this example, the working surface 2111 of the first phalanx 2110 contains silicone pad 2112 with a substantially flat surface, and the working surface 2121 of the second phalanx 2120 contains parallel ridges for increasing friction to receive silicon pad (not shown).

Now referring to FIGS. 2A-2C, the two joints contain a revolute joint (with the first shaft 2160) at the first phalanx and a universal joint 2170 (with the second shaft 2161 and the third shaft 2162) which contains a two-degree-of-freedom at the second phalanx 2120. One rotational axis x of the universal joint 2170 is parallel to the first phalanx's 2110 rotational axis y, enabling two independent degrees of freedom for flexion movements. The other degree of freedom of the universal joint 2170, perpendicular to the flexion axis, facilitates adduction/abduction movements. The universal joint 2170 contains a second shaft receiving portion 2171 which is sized and shaped to receive a portion of the second shaft 2161 so as to connect with the second phalanx, and a third shaft receiving portion 2172 which is sized and shaped to receive the third shaft 2162 so as to connect with the third phalanx 2130. The second shaft 2161 is arranged in a direction substantially perpendicular to the third shaft 2162, thereby providing two degrees of freedom at the universal joint 2170. The short, third shaft 2162 is configured to connect the universal joint 2170 and the third phalanx 2130, serving as a pivot point of the universal joint 2170. The use of the universal joint 2170 significantly reduces the complexity of the robotic fingers 2100 in performing adduction/abduction movements. The range of motion for each joint is various. In this example, the fingertip rotational joint (revolute joint) ranges from about 0°to 90°. The universal joint's 2170 range of motion in the flexion direction extends from about 0°to 90°, and in the adduction/abduction direction, it ranges from about −20°to 20°.

The third phalanx 2130 generally contains a baffle 2131 and a phalanx base 2132, and the universal joint 2170 is secured by the baffle 2131 of the third phalanx 2130 via the third shaft 2162. The baffle 2131 contains an upper slant face sized and shaped to receive or secure the lower end of the hydraulic actuators 2150A and 2150B (collectively 2150) and the second phalanx, and a lower face sized and shaped to connect with the phalanx base 2132.

A first hydraulic actuator 2140, which is driven by hydraulic power, is sized and shaped to be received between the first phalanx 2110 and second phalanx 2120, so to drive the flexion and extension of the first phalanx 2110, relative to the second phalanx 2120. A pair of second hydraulic actuators 2150A and 2150B, which are in expandable, bellows-type shape, are configured to be received between the second phalanx 2120 and the third phalanx 2130, to control the degrees of freedom of the second phalanx 2120 so as to drive the flexion, extension, adduction and/or abduction of the second phalanx 2120.

### Hydraulic Actuators

### 3.1. Construction of Example Hydraulic Actuator

### 3.1.1 Soft Hydraulic Actuator Design

Origami-Inspired Structure: The soft hydraulic actuators are designed based on origami principles, featuring bellows-type structures or accordion-shaped bellows that can expand and contract efficiently. This design allows for high expansion ratios and durability, making the actuators suitable for various manipulation tasks.

Materials: The hydraulic actuators are made in soft materials. In some examples, the hydraulic actuators are constructed from soft materials such as polyethylene, chosen for their toughness and extensibility. This ensures that the hydraulic 3 actuators can maintain their structural integrity under repeated pressure cycles and extreme positions.

### 3.2 Principles Involved

### 3.2.1. Hydraulic Actuation

Hydrostatic Pressure: The soft hydraulic actuators operate based on hydrostatic pressure. When the syringe compresses the hydraulic fluid, it increases the internal pressure, causing the actuator to expand. Conversely, when the fluid volume increases, the actuator contracts.

Elastic Deformation: The design of the actuators minimizes elastic deformation, ensuring a consistent relationship between the actuator length and the hydraulic fluid volume.

### 3.2.2. Compliance and Adaptability

Local Compliance: The soft actuators provide local compliance, enabling the robotic system to conform to the contours of objects and apply appropriate forces. This enhances the ability to perform delicate tasks and reduces the risk of damaging fragile objects.

Bidirectional Driving: The hydraulic system allows for bidirectional driving, meaning the actuators can both push and pull, providing more versatile control over movements.

### 3.3 Methodology

### Actuator Assembly

The soft hydraulic actuators are assembled by connecting the bellows-type structures to the syringe pumps via flexible hydraulic lines.

The materials are selected for their ability to withstand the pressures involved in hydraulic actuation while maintaining flexibility and durability.

### 3.4 Origami (bellows Type) Features

In some examples, the soft hydraulic actuation system, seamlessly integrates dexterity and compliance into a compact form. The refined origami (or Bellows type) actuators, exhibit exceptional airtightness, durability, and a high expansion ratio, contributing to the effective driving of the revolute joint.

In some examples, the design of the origami actuators revolves around two key aspects: customization of the actuator's behavior through design parameters and consideration of specific materials and fabrication methods based on functional requirements. In some examples, design parameters focus on modifying the zig-zag origami characteristics. In some examples, adjusting the relative angle between two adjacent zig-zag features, for example, allows for the alteration of the actuator's initial length. Similarly, in some examples, modifying the depth-to-diameter ratio influences the mechanical characteristics of the actuator during motion, while changing the number of origami layers directly impacts its expansion length.

### 3.5 Fabrication

In terms of fabrication, the actuator needs to meet the force output requirements of the dexterous hand, requiring a certain level of pressure resistance. Given the challenge of manufacturing small-scale, pressure-resistant, and airtight actuators, in some examples, blow molding is used as the fabrication method. In some examples, polyethylene, chosen for its toughness and extensibility, serves as the material for blow molding. In some examples, this choice ensures that the actuators can maintain thinness without compromising durability, even after undergoing repeated positive and negative pressure cycles and extreme position movements.

### 3.6 Hydraulic Driven Actuators

In some examples, the origami actuator is hydraulically driven. In contrast to pneumatic actuators, which exhibit notable compressibility, hydraulic actuators offer higher stiffness during interaction. For dexterous hand applications, lower stiffness is not always desirable, as it may require the introduction of a variable stiffness mechanism, thereby increasing system complexity and control challenges. The higher stiffness of the hydraulic actuators ensures a proportional relationship between the volume of the liquid and the length of the actuator even under external forces. This characteristic facilitates the driving of the two degrees of freedom in the configuration space of the universal joint: simultaneous elongation or shortening of both actuators induces flexion, while differential elongation and shortening resulted in adduction/abduction movements of the universal joint.

### 3.7 Integration With Robotic Systems

Modularity: The soft hydraulic actuators can be modularly integrated into various robotic systems. Each actuator can be independently controlled, providing a high degree of flexibility in designing robotic hands, arms, or other manipulators.

Compliance: The inherent compliance of the hydraulic actuators allows the robotic system to adapt to various shapes and apply appropriate forces without causing damage. This makes the mechanism suitable for delicate tasks.

### Example 3

### Example Hydraulic Actuator

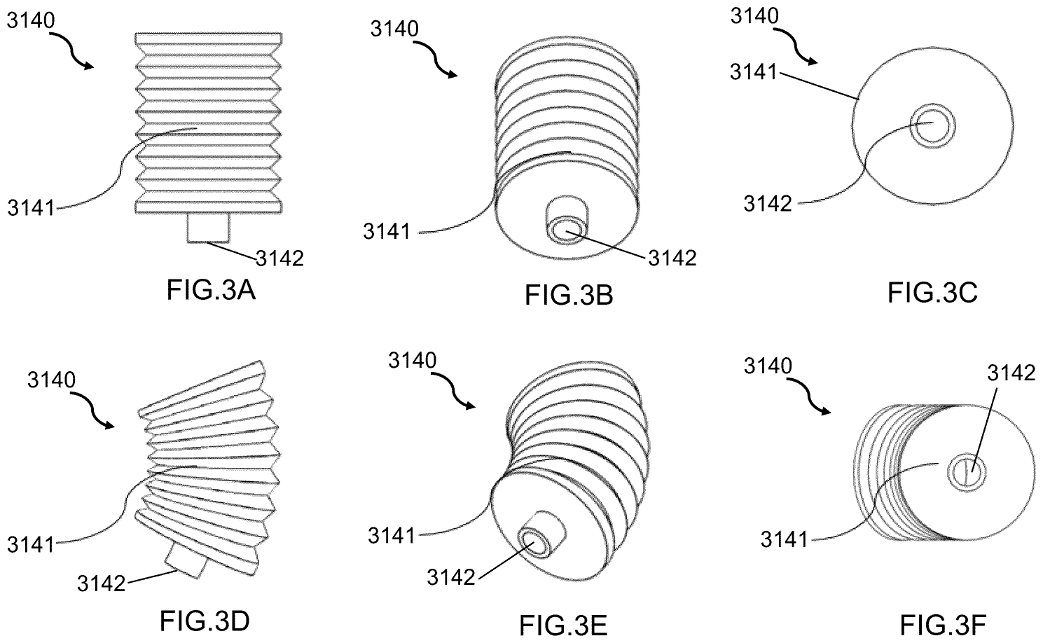

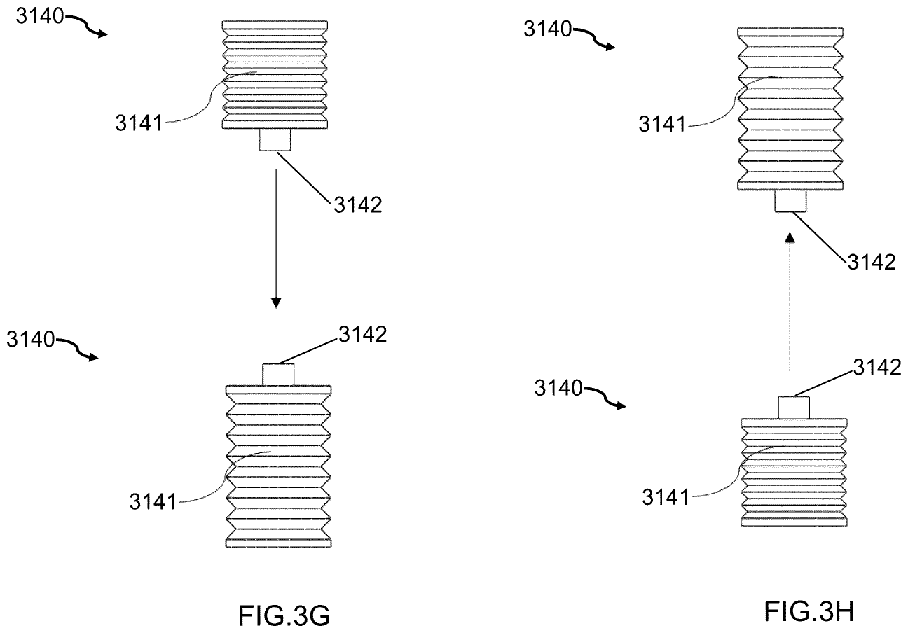

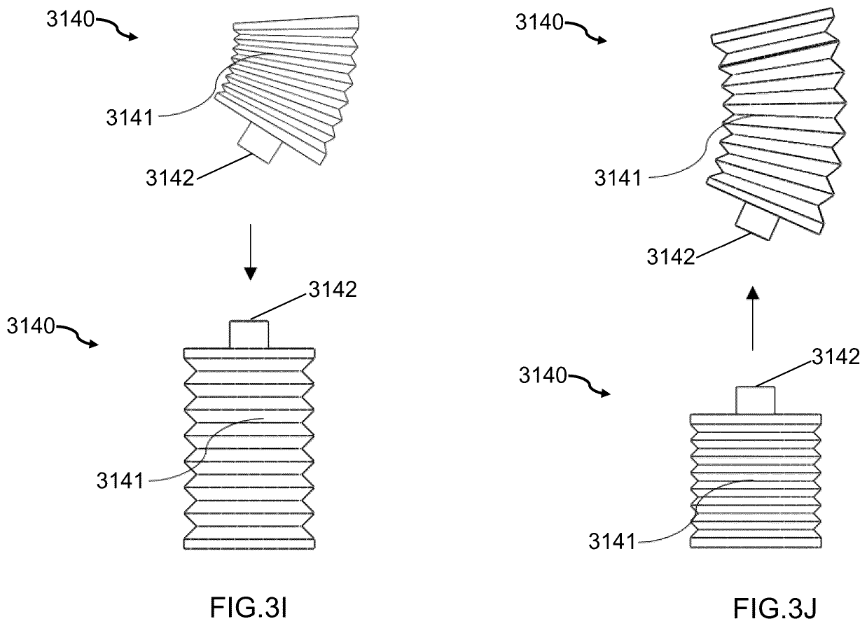

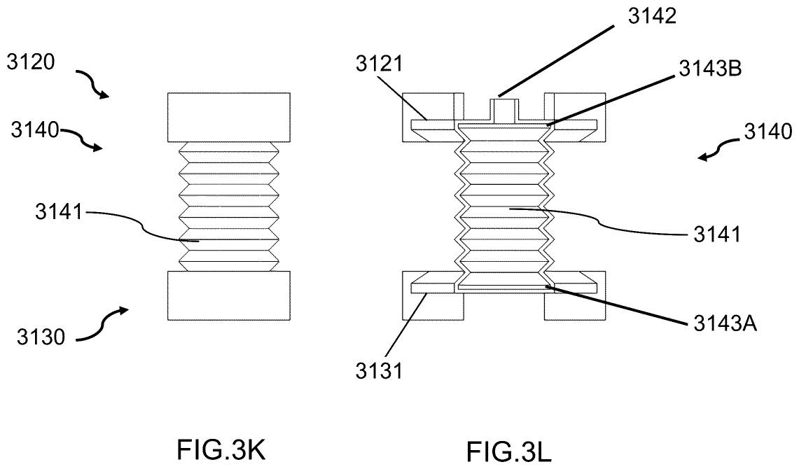

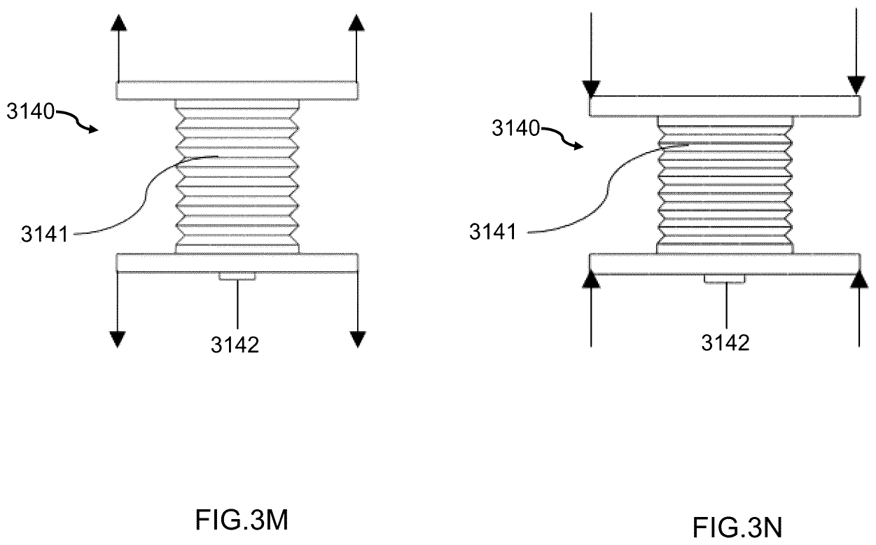

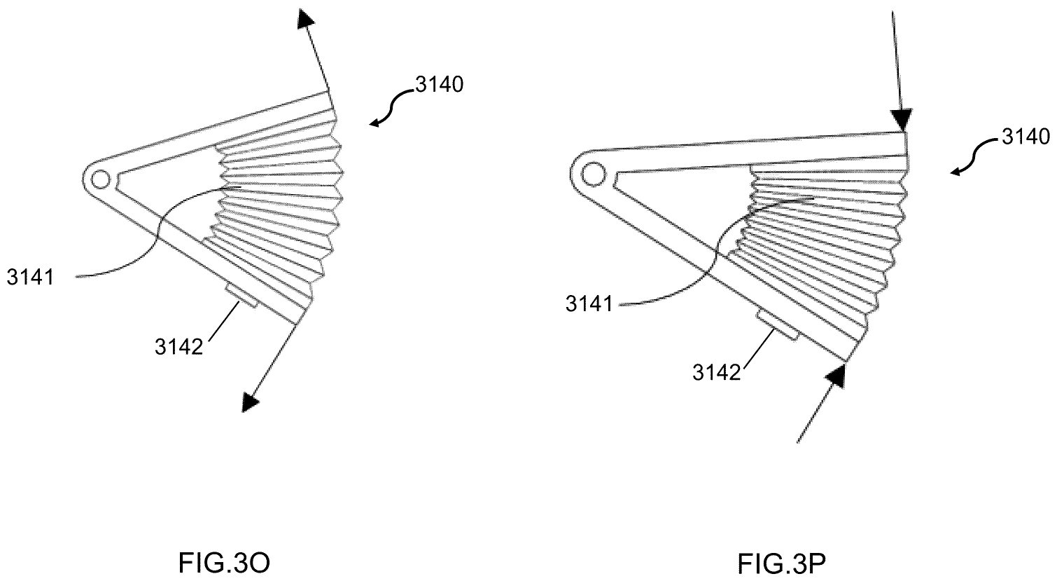

Now referring to FIGS. 3A to 3P showing the details of the example hydraulic actuator in different views. In this example, the example hydraulic actuator features bellows-type structures that can expand and contract efficiently (FIGS. 3A-3F). The hydraulic actuator 3140 contains a bellows-type deformable body 3141, defining a chamber therewithin, and an inlet 3142 for hydraulic fluid input. In this example, the inlet 3142 is connectable with a hose to deliver and fill the hydraulic fluid within the chamber. The chamber comprises a variable volume depending on the compressed/expanded state of the actuator. The inlet 3142 is sealed to prevent leakage afterwards. FIG. 3G (upper figure) showed that the actuator 3140, driven by hydraulic power, undergoes compression at both ends as the internal hydraulic pressure decreases; and (lower figure) the actuator 3140 extends as the internal hydraulic pressure increases. FIG. 3H (lower figure) showed that when the actuator 3140 compresses, decreasing the internal hydraulic pressure; and (upper figure) the actuator 3140, driven by hydraulic power, extends at both ends as the internal hydraulic pressure increases. FIG. 3I (upper figure) showed the actuator 3140 is in a bent state, driven by hydraulic power, undergoes compression at both ends as the internal hydraulic pressure decreases; and (lower figure) when the actuator 3140 extends, increasing the internal hydraulic pressure. FIG. 3J (lower figure) showed when the actuator 3140 compresses, decreasing the internal hydraulic pressure; and (upper figure) when the actuator 3140 is in bent state, driven by hydraulic power, extends at both ends as the internal hydraulic pressure increases. In other words, the actuator 3140 can undergo compression or extension in different amplitude (i.e., different degree of compressed/extended states) and bent states in response to the hydraulic pressure controlled by the hydraulic power applied. In other words, the relative movement between phalanges are controlled by the hydraulic actuation mechanism.

FIGS. 3K-3L showed the detailed locking structures of the actuator 3140 to install between two elements (e.g., phalanxes). In these figures, elements 3121 and 3131 represent partial structures of a second phalanx and a third phalanx, respectively. The actuator 3140 contains an inlet 3142 and a bellows-type deformable body 3141, which contains a first head portion 3143A in the form of a half convolution at one end, and a second head portion 3143B in the form of a half convolution at the opposite end. The first head portion 3143A and the second head portion 3143B are sized and shaped to match with and received in the corresponding receiving portions 3121 and 3131 of the two elements (e.g., the second and the third phalanxes), respectively, such that the actuator 3140 can be installed and locked to its desired position relative to the elements such as the phalanxes. These locking structures allow the actuator 31401 to be pulled and pushed in response to external force and/or hydraulic pressure.

FIG. 3M showed that the actuator 3140 is passively stretched due to external force applied, indicated by the arrows. FIG. 3N showed that the actuator 3140 is passively compressed due to external force applied, indicated by the arrows. In other words, the actuator 3140 can undergo stretching or compression in response to external force applied thereto.

FIG. 3O showed the actuator 3140 is in a bent state being passively stretched due to external force, when the actuator 3140 is installed between two elements (e.g., phalanxes) connected by a revolute joint. FIG. 3P showed the actuator 3140 is in a bent state being passively compressed due to external force, when the actuator 3140 is installed between two elements (e.g., phalanxes) connected by a revolute joint. In other words, the actuator 3140 can undergo stretching or compression in different bent states in response to external force applied thereto.

### Example 4

### Actuation of the First Phalanx

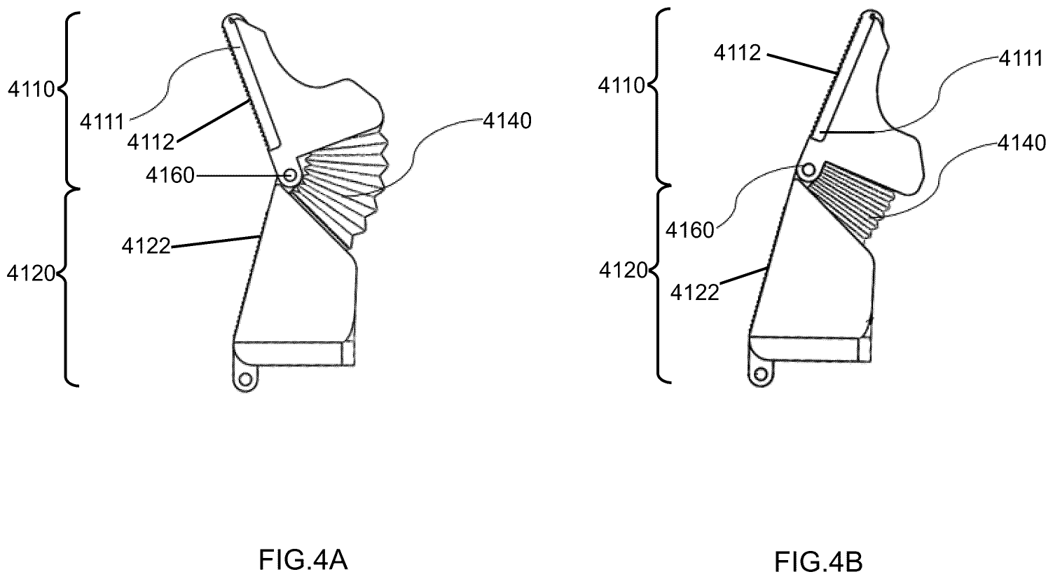

Now referring to FIGS. 4A to 4B, showing the actuation of the first phalanx controlled by the actuator in response to the hydraulic power. Silicone pad 4111 is provided at the first phalanx 4110, increasing the friction between the finger and the target object. Coating 4112 is provided on the fingertip to protect fragile target object. Another silicone pad 4122 is provided at the second phalanx, increasing the friction between the finger and the target object.

The first shaft 4160 connects the first phalanx 4110 and the second phalanx 4120, serving as the pivot point for the revolute joint 4160. The hydraulic bellows-type actuator 4140 is installed between the first phalanx 4110 and the second phalanx 4120, to control the degrees of freedom of the first phalanx 4110. In FIG. 4A, the actuator 4140 elongates due to an increase in hydraulic pressure. By increasing the hydraulic pressure, the actuator 4140 elongates, resulting in the bending of the first phalanx (as shown in FIG. 4A). In FIG. 4B, the actuator 4140 contracts due to a decrease in hydraulic pressure. By decreasing the hydraulic pressure, the actuator 4140 contracts, resulting in the stretching of the first phalanx (as shown in FIG. 4B). As such, the first phalanx 4110 is capable of flexion and extension.

### Example 5

### Actuation of the Second Phalanx

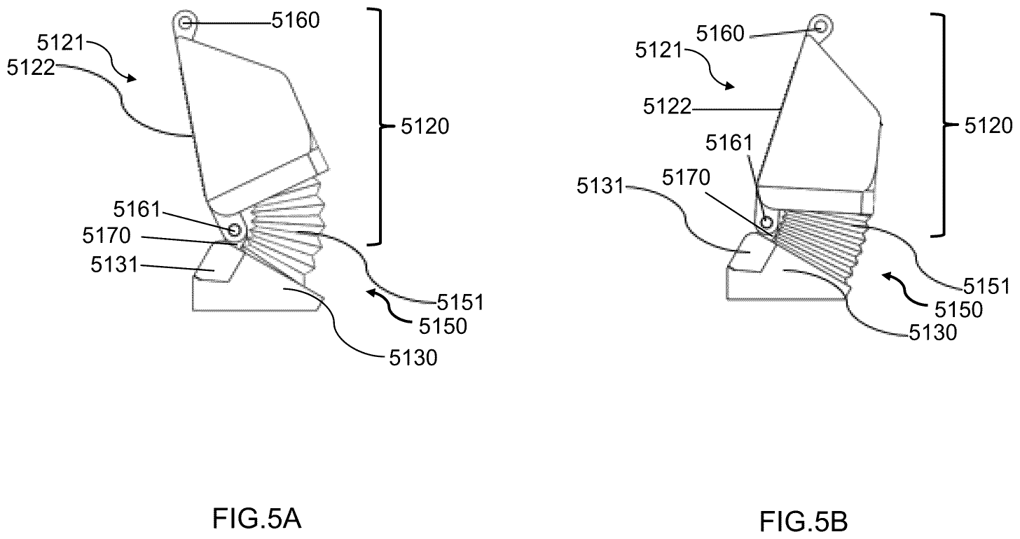

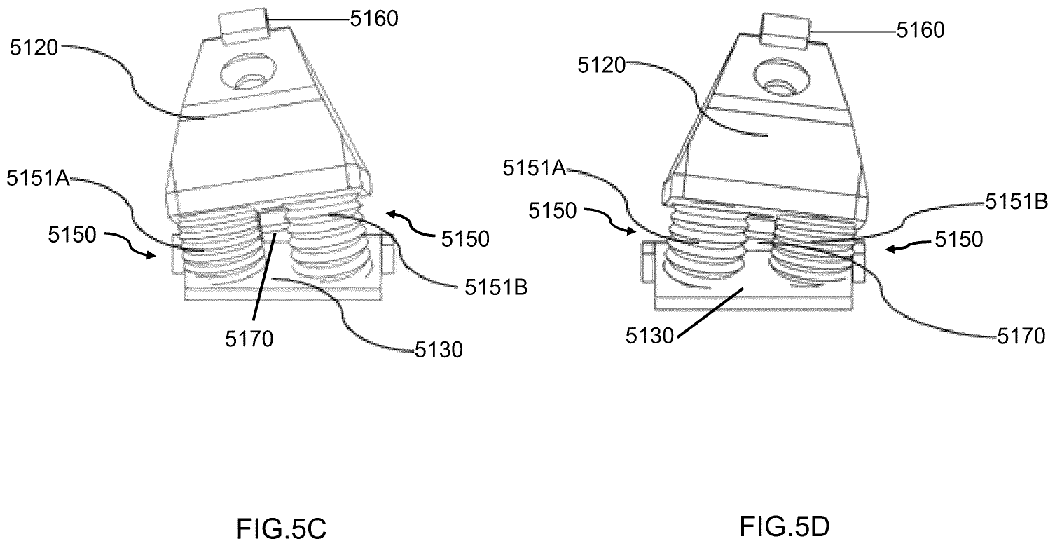

Now referring to FIGS. 5A to 5D, showing the actuation of the second phalanx controlled by the actuators 5151 in response to the hydraulic power. Silicone pad 5122 is provided at the second phalanx, increasing the friction between the finger and the target object.

The second shaft 5161 and a third shaft (not shown) connects the second phalanx 5120 and the third phalanx 5130 via the universal joint as joint pivot joints. Baffle 5131 of the third phalanx 5130 is used to secure the universal joint. The third phalanx 5130, connected to the phalanx base, is used to secure the two actuators 5151 and the universal joint.

In this example, a pair of hydraulic bellows actuators 5151A and 5151B (collectively 5151) are installed between the second phalanx 5120 and the third phalanx 5130, controlling the degrees of freedom of the second phalanx 5120. By increasing the hydraulic pressure, the pair of actuators 5151 elongates, resulting in the bending of the second phalanx 5120, as shown in FIG. 5A. By decreasing the hydraulic pressure, the pair of actuators 5151 compressed, resulting in the extension of the second phalanx 5120, as shown in FIG. 5B.

By controlling the hydraulic pressures applied to the pair of actuators separately, the pair of actuators 5151 may have different degrees of compression or elongation, resulting in full control in inclination towards a desired side. In FIG. 5C, by increasing the hydraulic pressure in the right actuator 5151B while decreasing it in the other the actuator 5151A, the actuators are driving the second phalanx 5120 incline towards the left side. The second phalanx is able to perform abduction movements. In FIG. 5D, by increasing the hydraulic pressure in the left actuator 5151A while decreasing it in the other the actuator 5151B, the actuators are driving the second phalanx 5120 incline towards the right side. The second phalanx is able to perform adduction movements.

As such, the second phalanx 5120 is capable of flexion, extension, adduction, and/or abduction.

### Sensors

In some examples, the provided robotic hands and systems may further contain sensors or perception system which is primarily dedicated to sensing the joint angles. In some examples, the perception system generally incorporates one or two types of sensors: a linear sliding potentiometer (linear displacement sensor) and/or an Inertial Measurement Unit (IMU).

The linear sliding potentiometer is positioned at the palm joint, providing feedback on the distance of the hand's opening and closing. Due to the potentiometer's highly stable performance, the data provides on palm distances serves as direct ground truth values. The IMU is configured to be operatively connect with or fixed to the proximal (second phalanx) and fingertip (first phalanx) links of the fingers, offering feedback on the two angles of the universal joint and the rotation angle of the fingertip.

The Inertial Measurement Unit (IMU) furnishes three-axis angular information to address the challenges of sensing joint angles. In some examples, commercially available IMUs that contains various MEMS (Micro-Electro-Mechanical Systems) integrated chips, encompassing a 3-axis accelerometer, a 3-axis gyroscope, a 3-axis magnetometer, and other measurement units such as barometers and thermometers for compensating drifts like temperature drift may be used. This integration facilitates the convenient incorporation of the IMU into small spaces, such as within a finger, while still providing multi-axis rotational information.

In some examples, the DexCo hand employs a commercially available MEMS IMU (ICM-20948, TDK InvenSense), a 9-axis IMU integrating accelerometers, gyroscopes, and/or magnetometers.

### Robotic Palm

Installed on the robotic palm, there is a controller designed for receiving sensor signals. In some examples, the controller is a customized PCB board designed for receiving sensor signals. A processer (not shown) is used to process sensor signals and is directly connected to the controller. In some examples, the processer is the Arduino Mega 2560. A flange is used for connecting the robotic hand to a robotic arm.

### Example 6

### Example Robotic Palm

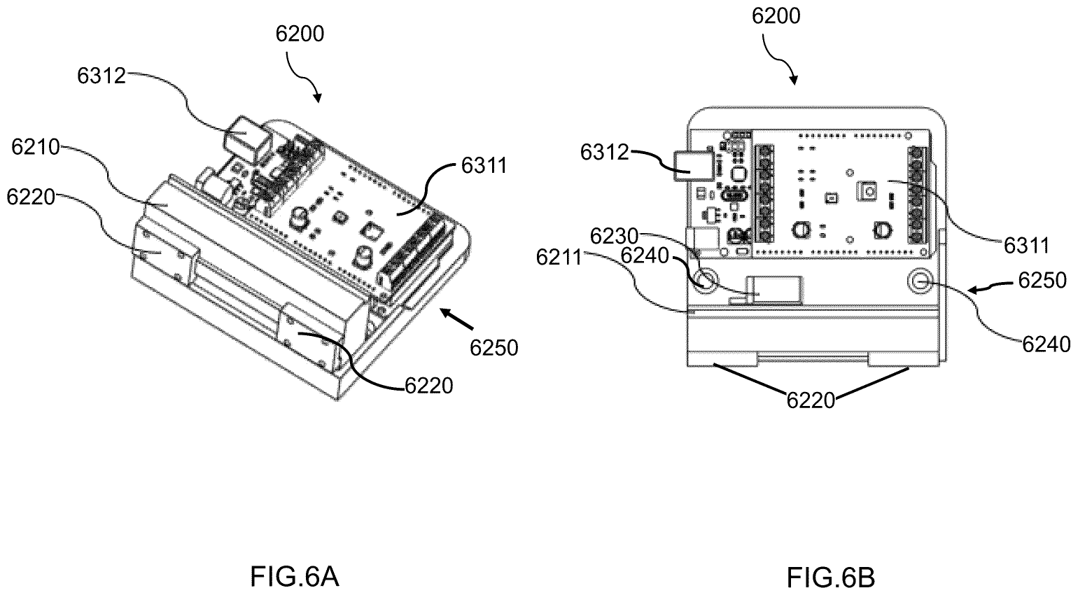

Now referring to FIGS. 6A-6B, showing an example robotic palm 6200. Robotic palm 6200 generally contains pneumatic slide rail 6210, and optionally other electronic components, such as microcontroller 6312, and PCB board or circuit 6311, operatively connect with the robotic hand.

In this example, the microcontroller 6312 is Arduino Mega 2560 is used to process sensor signals and is directly connected to the customized PCB board 6311. The customized PCB board 6311 is configured for receiving sensor signals.

In this example, the pneumatic slide rail 6210 serves as the palm for slidably mounting the robotic fingers and can adjust the width of the robotic hand (i.e., the distance between the two robotic fingers). In this example, two finger pneumatic gripper SMC MHF2-12D2R (SMC Pneumatics) is used, which is pneumatically driven and can withstand a range of air pressures, supporting a relatively large gripping force (e.g., 48 N). With two pneumatic inputs, the slide can control both stiffness and position. It has a travel distance of about 60 mm, which provides significant dexterity for fine in-hand operations during experimental tasks. Observations from experiments suggested that increasing the slide's travel distance could further enhance operational dexterity.

A pair of sliders 6220 are provided on the slide rail 6210. Together they are sized and shaped to connect with the finger (phalanx base), such that the finger can slide along the guide rail to adjust the width of the palm. The pneumatic slide rail 6210 contains an installed groove 6211 on one side, while the other side is sized and shaped to match with the flange 6250 to prevent loosening. FIG. 6B also shows the protruding portion 6230 on the flange 6250, used for mounting the linear displacement sensor. The flange 6250 is equipped with mounting holes 6240 used to secure the flange 6250 to the robotic arm.

### Example 7

### Example Robotic Hand With Three Robotic Fingers

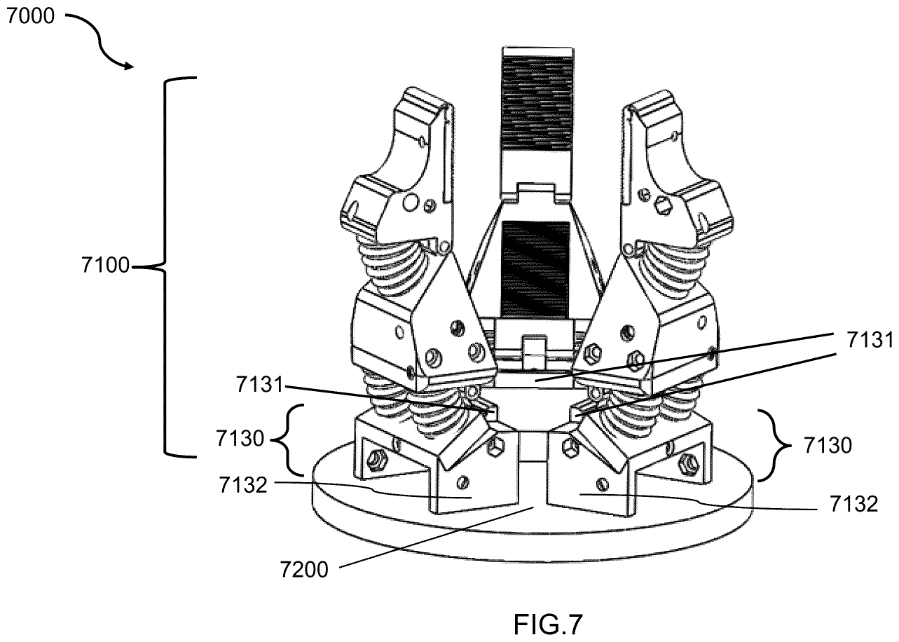

FIG. 7 showed another example robotic hand 7000. In this example, three robotic fingers 7100 are provided, and they are equidistantly arranged about the central axis of the robotic finger. The structures and components of each robotic finger 7100 are structurally similar to the robotic fingers described in Example 1 or 2, but the robotic palm 7200 is substantially a circular plate, and each of the phalange base 7132 of the third phalange 7130 is sized and shaped to be fixedly connect with the robotic palm 7200. Each of the baffle 7131 contains an upper slant face sized and shaped to receive or secure the lower end of the hydraulic actuators and the second phalanx, and a lower face sized and shaped to connect with the phalanx base 7132. The three robotic fingers 7100 are operatively connected with the robotic palm 7200 which provides a central working space for object manipulations.

### Example 8

### Example Robotic Hand With Four Robotic Fingers

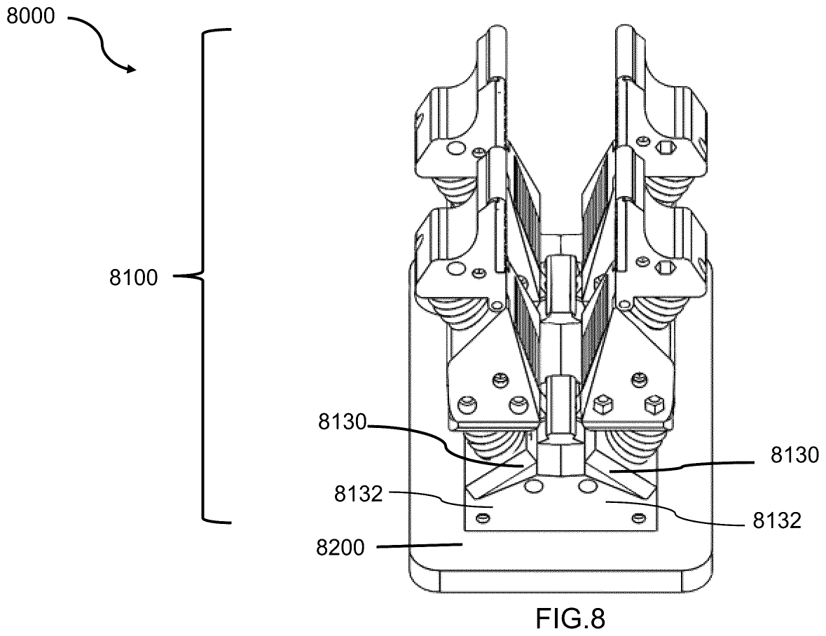

FIG. 8 showed another example robotic hand 8000. In this example, four robotic fingers 8100 are provided and they are arranged as two adjacent pairs of two oppositely arranged robotic fingers. The structures and components of each robotic finger 8100 are structurally similar as the robotic fingers described in Example 1 or 2, but the robotic palm 8200 is substantially a rectangular plate with rounded corners, and each of the phalange base 8132 of the third phalange 8130 is sized and shaped to be fixedly connect with the robotic palm 8200. Each of the baffle contains an upper slant face sized and shaped to receive or secure the lower end of the hydraulic actuators and the second phalanx, and a lower face sized and shaped to connect with the phalanx base 8132. The four robotic fingers 8100 are operatively connected with the robotic palm 8200 which provides a working space for object manipulations.

### Example 9

### Another Example Robotic Hand With Four Robotic Fingers

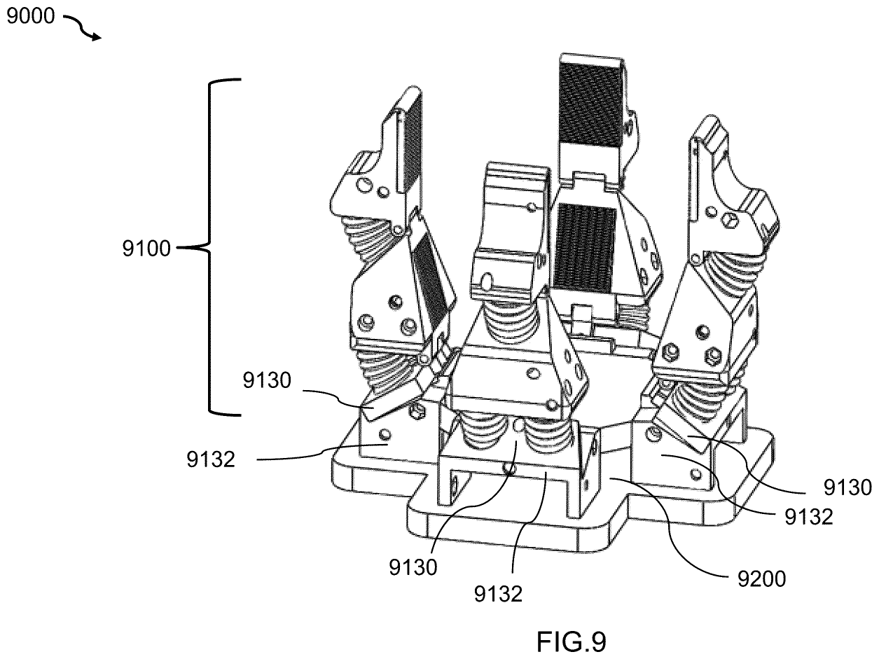

FIG. 9 showed another example robotic hand 9000. In this example, four robotic fingers 9100 substantially are rectangularly arranged. The arrangement of the fingers generally forms a central, generally rectangular shaped working space. The structures and components of each robotic finger 9100 are structurally similar as the robotic fingers described in Example 1 or 2, but the robotic palm 9200 is substantially a plate in cross shape with rounded corners, and each of the phalange base 9132 of the third phalange 9130 is sized and shaped to be fixedly connect with the robotic palm 9200.

### Robotic System

In some examples, a robotic system containing a robotic hand is provided. In some examples, the robotic hand is operatively connect with a robotic arm to form the robotic system. In one example, the robotic arm is LBR iiwa robotic arm (KUKA). In some examples, the robotic system optionally contains or operatively connects with one or more the following features, components or systems:

### 10.1 Control System

A central control system or controlling unit which processes sensor data and generates control signals for the hydraulic driving unit. In some examples, controlling unit is incorporated in hydraulic driving unit and the hydraulic driving unit contains stepper motor driver to drive the stepper motor (syringe pump) to actuate the hydraulic syringe.

Algorithms are provided and executed in the control system to ensure coordinated movements of the actuators, enabling complex manipulation tasks.

### 10.2 Operational Protocol

In some examples, operational protocol or operating unit is included in the system. The system can be operated through either a teleoperation interface or pre-programmed routines. In some examples, the control system interprets high-level commands and translates them into specific movements for each actuator.

The compliance and adaptability of the actuators allow the system to interact safely with various objects, performing tasks that require precision and delicacy.

### 10.3 Teleoperation Controller

In some examples, a dedicated teleoperation controller is operatively connected with a robotic hand for operating the DexCo hand in versatile, human-inspired fine in-hand manipulation tasks. In some examples, the DexCo hand exhibits successful in-finger manipulation, maintaining degrees of freedom while securely sustaining the pinch. Moreover, it excels in finger-environmental manipulation, adeptly grasping specific targets in cluttered environments that necessitate abundant interaction with surrounding objects. This includes altering the environment to facilitate grasping, showcasing a significant capability akin to the dexterity of the human hand.

### 10.4 System Actuation

In some examples, the actuation of the hand is divided into two integral components: origami actuators seamlessly integrated onto the robotic hand and a hydraulic driving unit such as a syringe pump system situated at the back end. In some examples, each origami actuator is equipped with a syringe pump as its driver. In some examples, the syringe pump contains a syringe, a stepper motor, a motor driver, and a magnetic encoder. In some examples, the syringe is directly linked to or connect with the origami actuator, propelling its movement. In some examples, when the volume inside the syringe is compressed, the origami actuator elongates; conversely, as the volume increases, the origami actuator shortens. In some examples, this actuation method, referred to as direct pumping in, allows the syringe to utilize volumes ranging from 10 ml to 250 ml, precisely matching the volume of the origami actuator. To achieve high-speed actuation and substantial output force, in some examples, a 57 stepper motor is chosen as the driver for the syringe pumps. In some examples, the 57 stepper motor can efficiently drive a 250 ml syringe at high speeds. In some examples, the synchronization of multiple stepper motors is accomplished through the IIC bus in conjunction with a microcontroller. This approach has successfully achieved low-latency synchronous movement within ten stepper motors, meeting the stringent requirements for synchronized control of multiple degrees of freedom essential for the dexterous hand in this example. Additionally, in some examples, magnetic encoders provide high-precision feedback on the position of the stepper motors, facilitating closed-loop control of the syringe pumps.

### 10.5 Hydraulic System

Syringe Pumps: In some examples, the actuators are driven by a hydraulic system. In some examples, hydraulic system contains one or more syringe pumps controlled by stepper motors. In some examples, each actuator is connected to a syringe, which modulates the hydraulic fluid volume to cause expansion or contraction.

Control Mechanism: In some examples, stepper motors are used to precisely control the movement of the syringes, allowing for accurate modulation of the hydraulic fluid and, consequently, the actuator movements.

### Example 10

### Example Robotic Systems

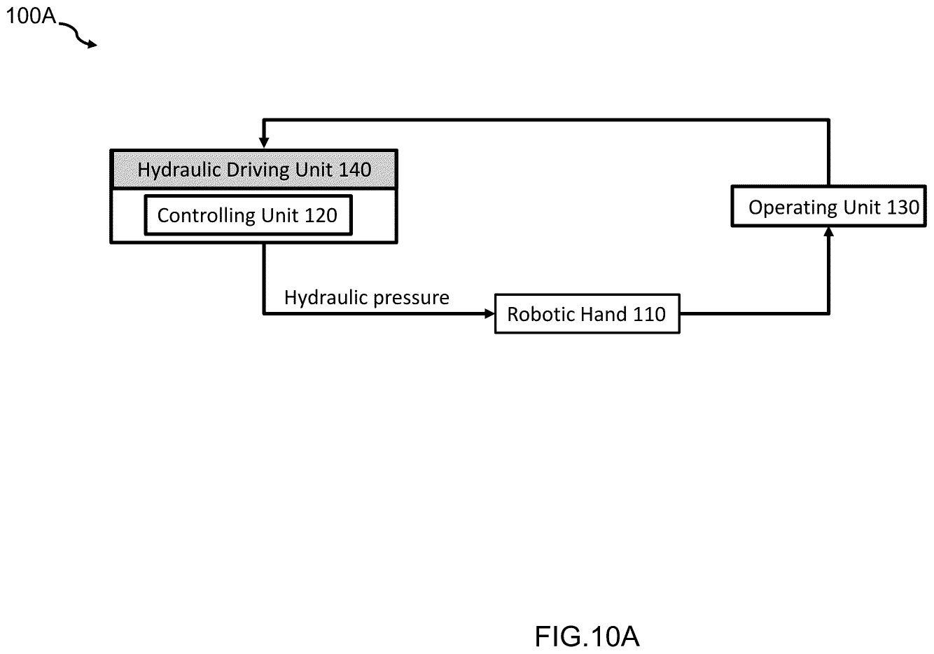

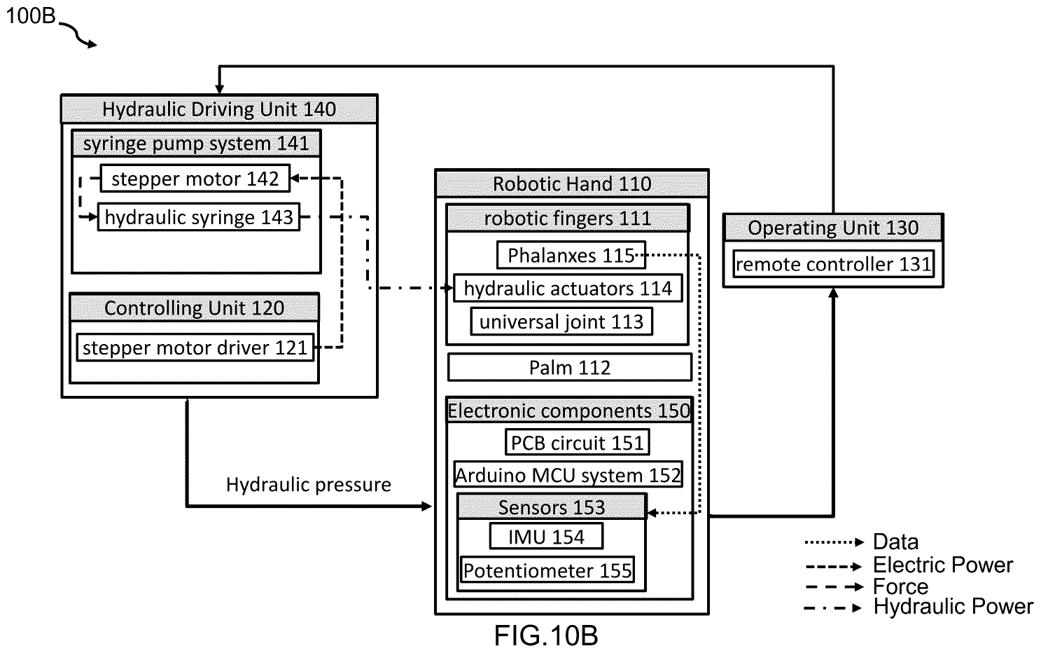

Now referring to FIG. 10A, showing an example robotic system 100A. The robotic system 100A generally contains a robotic hand 110. In this example, the robotic system 100 further contains an operating unit 130, and a hydraulic driving unit 140, operatively connect with the robotic hand 110. In this example, the hydraulic driving unit 140 contains a controlling unit 120.

In this example, the operating unit 130 is a teleoperation interface allowing a user to manipulate the robotic hand 110. The controlling unit 120 processes sensor data and/or generates control signals for the hydraulic driving unit 140. The hydraulic driving unit 140 provides controlled hydraulic pressure to the actuators of the robotic hand.

Now referring to FIG. 10B, in one implementation, the robotic system 100B contains the robotic hand 110 which generally contains a palm 112 and multiple robotic fingers 111, each robotic finger 111 contains components such as joints (e.g., universal joint 113), hydraulic actuators 114 and phalanxes 115, operatively connected with each other. The operating unit 130 is a remote controller 131 as a human operational interface to send operational signals to the hydraulic driving unit 140. The hydraulic driving unit 140 contains a syringe pump system 141 and a controlling unit 120. In this example, the syringe pump system 141 contains the following: a stepper motor 142 and a hydraulic syringe 143, and optionally contains or operatively connects with one or more of the following: a power source such as 24V DC power, a syringe locker, an electromagnetic encoder and an acrylic syringe pump box that is used to house the components of syringe pump. The controlling unit 120 contains a stepper motor driver 121 serving as a stepper motor controller to provide electronic power to the stepper motor 142, in response to the operational signals. The stepper motor 142 drives the force to the hydraulic syringe 143 to produce hydraulic power to the actuator to actuate the robotic hand 110. In this example, the robotic hand 110 further contains electronic components 150 such as PCB circuit 151, Arduino MCU system 152 and sensors 153 such as IMU 154 and potentiometer 155. Sensors 153 receive data associated with the movement and joint angles of the robotic hands 110.

### Applications

### 11.1 DexCo Hand Fine In-hand Manipulation Tasks Demonstration

In some examples, the provided example robotic hand, DexCo Hand, integrated into the syringe pump system has showcased remarkable capabilities in executing a diverse range of fine in-hand manipulation tasks.

Beyond conventional pinch and power grasping, in some examples, the DexCo Hand excels in challenging scenarios such as cluttered picking, assembling light bulbs, and unscrewing bottle caps, involving intricate environmental constraints. Additionally, it pioneers in tasks previously unexplored or deemed unachievable by existing dexterous hands, such as opening plastic bags, counting cards, and sorting medications, showcasing its versatility in fine in-hand manipulation.

In some examples, the DexCo hand serves as a practical application of the soft hydraulic actuation mechanism. It features modular fingers equipped with the soft hydraulic actuators, providing three degrees of freedom (DoF) per finger. In some examples, the fingers are capable of flexion, extension, adduction, and abduction movements, replicating human-like dexterity. In some examples, the soft hydraulic actuation mechanism enables the DexCo hand to perform fine in-hand manipulation tasks, such as picking and sorting small objects, screwing and unscrewing items, and handling delicate materials.

### Example 11

### Fine In-hand Manipulation Tasks Demonstrations

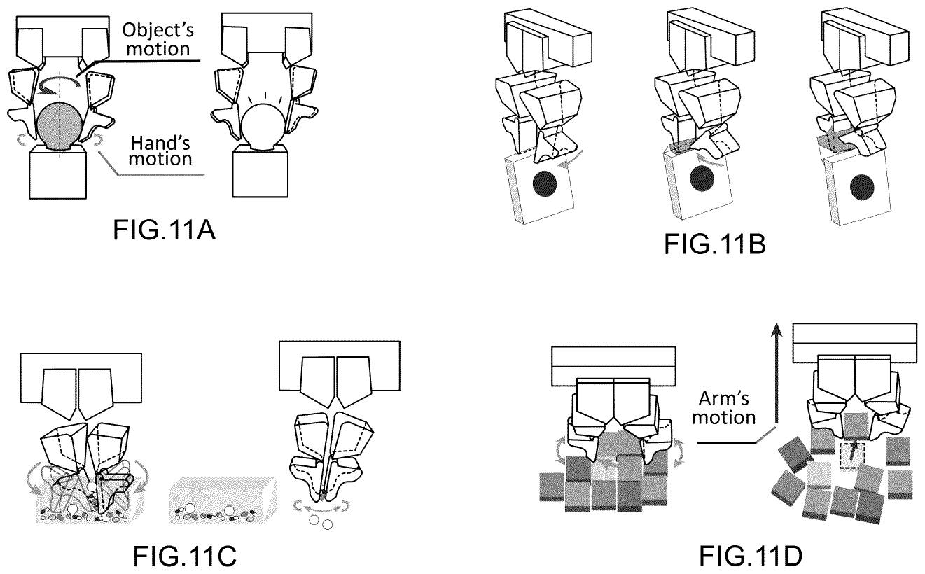

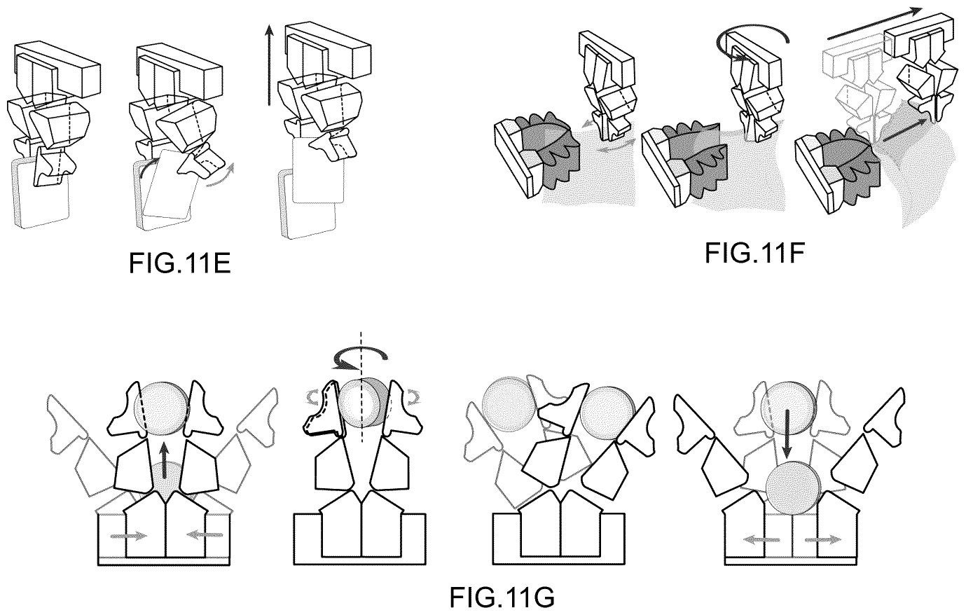

Now referring to FIGS. 11A-11G, showing various fine in-hand manipulation tasks demonstrated by an example robotic hand and system thereof. The example robotic hand as described in Example 1 which contains two fingers and the example robotic system as described in Example 10 were used.

Light bulb assembly task, as shown in FIG. 11A, involved first tightening the bulb from an untouched state and then unscrewing it. This was achieved through the DexCo hand's repeated forward and backward twisting motions. To demonstrate the robustness offered by compliance, the hand's central axis was offset from the bulb's axis on xy planes. In terms of the palm, a wider palm needed a larger flexion at joints to contact with the object. As a larger flexion angle resulted in a smaller y-axis motion range, as analyzed in the dexterity mechanism, the palm's width can adjust the twisting range.

Card box opening task is shown in FIG. 11B. The box's top end had a semi-circular opening, typically opened by inserting fingers. The DexCo hand employed a similar mechanism, opening the box from above using its flexion dofs or the side using its adduction/abduction dofs. During this process, the robot arm remained stationary.

Pill sorting is depicted in FIG. 11C. The process included picking multiple pills from a pile and then categorizing them into different piles using fine in-hand manipulation. This task required the DexCo hand to utilize its fingertip dexterity to pick a portion of the pills from a cluttered arrangement, followed by separating the small particles using fingertip sliding, akin to the human hand sprinkling powder.

Cluttered bin picking (FIG. 11D) featured dense hand-environment interaction, which was a great challenge for robot to operate in unstructured environment. In the real word, pick and place is not enough because objects are always stacked or gathered in a confined space. From our result, the dexterity at the fingertip of the DexCo hand demonstrated a great capability to manipulate in clutter. We believe that the manipulation for grasping capability of the DexCo hand can solve this cluttered bin picking challenge.

Card-counting task is illustrated in FIG. 11E. Human hands use the thumb and index finger to swiftly extract cards from a deck, with the other hand assisting. The DexCo hand mimicked this, with a lower soft hand (not shown) holding the deck for assistance. The DexCo hand used its fingertip dexterity to first separate the top card, with no arm movement. Once the card was separated, the arm moved upwards to extract it. Without this fine in-hand manipulation, consecutive cards would be removed together.

Opening a plastic bag is shown in FIG. 11F. The left soft hand, attached to the end of a KUKA robot, adjusted its opening and closing through pneumatic control. This task involved initially manipulating the unopened, transparent thin plastic bag with the fingertips to open it and grip one edge. The bag was then repositioned for the left soft hand to grasp the other edge, and the right DexCo hand pulled it open. The success of the bag-opening phase depended on the dexterity and compliance of the fine in-hand manipulation. During the bag-stretching phase, sufficient gripping force was required while pinching with the DexCo hand.

Caging manipulation and in-hand rotation, FIG. 11G, depicts involving two sliding primitives along the x and y axes and two translation primitives along y and z axes. The palm's role here was to extend the range of sliding, perform translational movement, and accommodate a wider range of object diameters. The hand's local compliance also increased the safety margin during manipulation, reducing control difficulty.

The results demonstrated that the combination of dexterity and compliance in the DexCo hand enabled it to perform fine in-hand manipulation skills comparable to human capabilities. The importance of adduction/abduction and palm movements was highlighted, as they involved in certain manipulation tasks, enhancing efficiency and robustness. In contrast, without these movements, tasks might necessitate complex sensory feedback, wrist and arm movements, and intricate modeling and control. This underscored the significant role played by dexterity and compliance in enhancing the overall manipulation capability of robotic hands.

The exemplary embodiments of the present invention are thus fully described. Although the description referred to particular embodiments, it will be clear to one skilled in the art that the present invention may be practiced with variation of these specific details. Hence this invention should not be construed as limited to the embodiments set forth herein.

For example, elements, components, systems and methods described in various examples and figures can be incorporated into or replaced with other elements, components, systems and methods in other various examples and figures.

For example, in certain embodiments, two, three or four robotic fingers containing three phalanxes are described, but different types of robotic fingers, different numbers of phalanxes (e.g., two, three, four, five, six, seven, eight, nine, ten or more), different arrangements, different sizes and shapes (oval, circular, triangular, rectangular, etc.) of the robotic fingers and/or the phalanxes may be used according to the practical need.

For example, in certain embodiments, individual robotic finger comprises silicone pads provided at working faces at the first and second phalanxes, but different sizes, shapes and formats of working faces (e.g., with or without pads, with or without surface providing friction, etc.), other materials of the pads (e.g., rubbers, polymers, etc.) may be used.

For example, in certain embodiments, certain arrangements of two or more robotic fingers are described, but different arrangements of robotic fingers (e.g., three or more adjacent sets of two oppositely arranged robotic fingers, or irregularly arranged etc.), with different numbers of robotic fingers (e.g., five, six, seven, eight, nine, ten or more) may be used.

For example, in certain embodiments, individual robotic fingers comprise three hydraulic actuators, one provided between the first and second phalanxes while two provided between the second and third phalanxes, are described, but different arrangements, positions, numbers, sizes and shapes of hydraulic actuators may be used.

For example, in certain embodiments, pneumatic slide rails are configured as robotic palms for slidably mounting the robotic fingers capable of adjusting the width of the robotic hand are described, but other mounting mechanisms and/or components (e.g., gears, linkages, slides, cable drives, etc.), and other driving means (e.g., motor-driven, etc.) may be used.

For example, in certain embodiments, the actuator contains head portions configured to be received in receiving portions of the phalanxes, and the head portions is in the shape of half convolutions, but other sizes, shapes of head portions and other mounting mechanisms may be used.

What is claimed is:

1. A robotic hand, comprising:
a plurality of robotic fingers; and
a robotic palm, configured to operatively connect with the plurality of robotic fingers,
wherein individual robotic finger comprises:
a first phalanx;
a second phalanx; and
a first hydraulic actuator, configured to operatively connect the first phalanx with the second phalanx,
wherein the first hydraulic actuator comprises a soft, bellows-type deformable body, such that when in operation, the first hydraulic actuator is switchable between at least a compression status and an extension status, in response to external force and/or hydraulic pressure applied thereto.

2. The robotic hand of claim 1, wherein the first hydraulic actuator is operatively connected with and driven by a hydraulic system comprising a syringe pump.

3. The robotic hand of claim 2, wherein the syringe pump is configured to be controlled by a stepper motor.

4. The robotic hand of claim 1, wherein the bellows-type deformable body is configured to connect with the syringe pump via flexible hydraulic line.

5. The robotic hand of claim 1, wherein the individual first phalanx and/or the individual second phalanx comprise a working face comprising a silicone pad thereon.

6. The robotic hand of claim 1, wherein the robotic finger further comprises a third phalanx and at least one second hydraulic actuator, wherein the at least one second hydraulic actuator is configured to operatively connect the second phalanx with the third phalanx.

7. The robotic hand of claim 1, wherein the robotic finger further comprises a revolute shaft connecting the first phalanx with the second phalanx.

8. The robotic hand of claim 6, wherein the robotic finger further comprises a universal joint connecting the second phalanx with third phalanx.

9. The robotic hand of claim 8, wherein the third phalanx further comprises a baffle for securing the universal joint.

10. The robotic hand of claim 6, wherein the third phalanx further comprises a phalanx base for connecting third phalanx with the robotic palm.

11. The robotic hand of claim 1, wherein the robotic finger further comprises at lease one proprioceptive sensor operatively connect with individual actuator.

12. The robotic hand of claim 11, wherein the at least one proprioceptive sensor comprises IMU and/or potentiometer.

13. The robotic hand of claim 1, wherein the robotic palm comprises a pneumatic slide rail, and the robotic hand is configured to slidably connect with the pneumatic slide rail.

14. The robotic hand of claim 6, wherein each of the first hydraulic actuator and the at least one second hydraulic actuator comprise a head portion at each opposing end, individual first phalanx, second phalanx and third phalanx, if present, comprises a receiving portion configured to receive the head portion.

15. A robotic hand, comprising:
a plurality of robotic fingers; and
a robotic palm, configured to operatively connect with the plurality of robotic fingers,
wherein individual robotic finger comprises:
a first phalanx;
a second phalanx;
a third phalanx;
a first hydraulic actuator, configured to operatively connect the first phalanx with the second phalanx;
a pair of second hydraulic actuators, wherein the pair of second hydraulic actuators are configured to operatively connect the second phalanx with the third phalanx;
a revolute joint connecting the first phalanx with the second phalanx; and
a universal joint connecting the second phalanx with the third phalanx; and
wherein each of the first hydraulic actuator and the pair of second hydraulic actuators comprise a soft, bellows-type deformable body, such that when in operation, the first hydraulic actuator and the pair of second hydraulic actuator are switchable between at least a compression status and an extension status, respectively, in response to external force and/or hydraulic pressure applied thereto.

16. A robotic system, comprising:
a robotic hand as claimed in claim 1; and
optionally a robotic arm, operatively connected with the robotic hand.

17. The robotic system, further comprising:
a hydraulic driving unit, configured to provide hydraulic pressure to the robotic hand; and
an operating unit, configured to provide operating signal to the hydraulic driving unit.

18. The robotic system of claim 17, wherein the hydraulic driving unit further comprises a controlling unit, configured to provide control signals to the hydraulic driving unit.

19. The robotic system of claim 17, wherein the hydraulic driving unit comprises a syringe pump system.

20. The robotic system of claim 19, wherein the syringe pump system comprises a stepper motor and a hydraulic syringe, and the controlling unit comprises a stepper motor driver.
